(19) United States
(12) Patent Application Publication
(10) Pub. No.: US 2008/0257917 A1
(43) Pub. Date: Oct. 23, 2008

(54) Container to Receive and Dispense a Measured Amount of Particulate Material

(76) Inventor: Adam E. Lee, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/632,391

(22) PCT Filed: Jul. 12, 2005
(86) PCT No.: PCT/AU05/01019

§ 371 Date: Jun. 16, 2008

(30) Foreign Application Priority Data
Jul. 12, 2004 (AU) 2004903819

(51) Int. Cl. G01F 11/26

(52) U.S. Cl. 222/456; 222/454

(57) ABSTRACT

A container (1) having an interior (5) to receive particulate material (7), said container (1) having: a passage (10) extending between said interior (5) to an opening (15) by which said material (7) is dispensed from said container (1); means located along said passage (10) and operable to limit a measured amount of said material (7) to be dispensed from said container (1) at one time; said means including surfaces (17a-d) offset from each other to alter a direction of said passage (10) to thereby define said measured amount.

### FIELD OF THE INVENTION

The present invention relates to containers and, in particular, containers to receive and dispense granular or particulate materials.

### BACKGROUND OF THE INVENTION

There are many containers to dispense materials. However, particular problems arise when dispensing granular or particulate materials, such as, sugar, sand, salt, grains, nuts, coffee, 100 and 1000's and washing powder, for example. The main problem with such containers is that it is difficult to dispense a measured amount without the use of a further item such as a measuring spoon or cup. Also, if the container is placed upside down the contents will flow out.

Some containers include nozzles, caps or heads to limit the flow of the container contents. These nozzles, caps and heads become easily blocked under the weight of the material. Typically, containers also require a minimum amount of material to function, won't completely empty and/or have complicated arrangements such as moving parts to dispense the material from the container.

Accordingly, there is a need to provide a dispenser for granular or particulate materials that dispenses a measured amount of material from a container, is simple and affordable and prevents excess material exiting the container even when the container is placed at unsuitable angles.

### OBJECT OF THE INVENTION

It is an object of the present invention to overcome or ameliorate some of the disadvantages of the prior art, or at least to provide a useful alternative.

### SUMMARY OF THE INVENTION

There is firstly disclosed herein a container having an interior to receive particulate material, said container having:

a passage extending between said interior to an opening by which said material is dispensed from said container;

means located along said passage and operable to limit a measured amount of said material to be dispensed from said container at one time;

said means including surfaces offset from each other to alter a direction of said passage to thereby define said measured amount.

Preferably, said surfaces form a first passage section extending from said interior, a second passage section extending to said opening and a third passage section defining a chamber between said first and second sections.

Preferably, said sections substantially reverse the direction of said passage from said interior to said opening.

Preferably, said offset surfaces are angularly offset.

Preferably, said material in use moves from said interior to said chamber to settle until dispensed, said measured amount being defined by the amount of said material located in said chamber before said material within said first section blocks said first section, said first section unblocking once said material within said chamber is dispensed from said container.

Preferably, when said container is inverted, said material in said first section is inhibited from exiting said container.

Preferably, said interior includes a wall angularly offset to a side of said container.

Preferably, said side of said container is a container base.

Preferably, said container is integrally formed.

Preferably, said passage forms a spiral.

Preferably, said container includes a lid or cap.

Preferably, said lid or cap includes a first aperture to access said opening. Preferably, said lid or cap includes a second aperture to access said interior.

### BRIEF DESCRIPTION OF THE DRAWINGS

Preferred embodiments of the invention will now be described, by way of example only, with reference to the accompanying drawings, in which:

FIG. 1 is a side view of an embodiment of the invention;

FIG. 2 is a side view of a further embodiment of the invention;

FIG. 3 is a side view of another embodiment of the invention;

FIG. 4 is a parts exploded perspective view of an alternate embodiment of the invention;

FIG. 5 is a top perspective view of FIG. 4;

FIGS. 6a-6c are side views of alternate embodiments of the invention;

FIG. 7a is a side view of FIG. 1 in a first use position;

FIG. 7b is a side view of FIG. 1 in a second use position;

FIG. 7c is a side view of FIG. 1 in a third use position;

FIG. 7d is a side view of FIG. 1 in a fourth use position;

FIG. 7e is a side view of FIG. 1 in a fifth use position;

FIG. 7f is a side view of FIG. 1 in a sixth use position; and

FIG. 7g is a side view of FIG. 1 in a seventh use position.

### DETAILED DESCRIPTION OF THE PREFERRED EMBODIMENTS

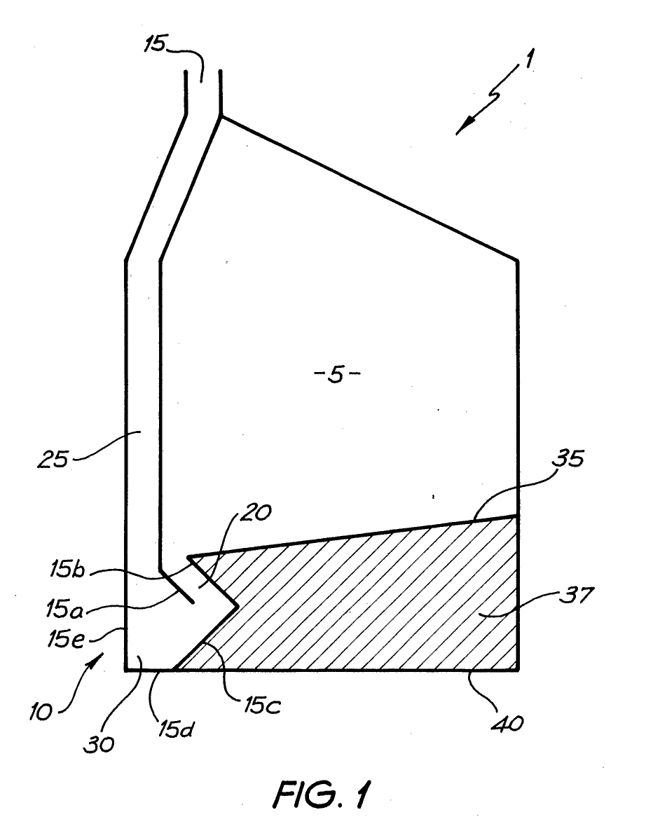

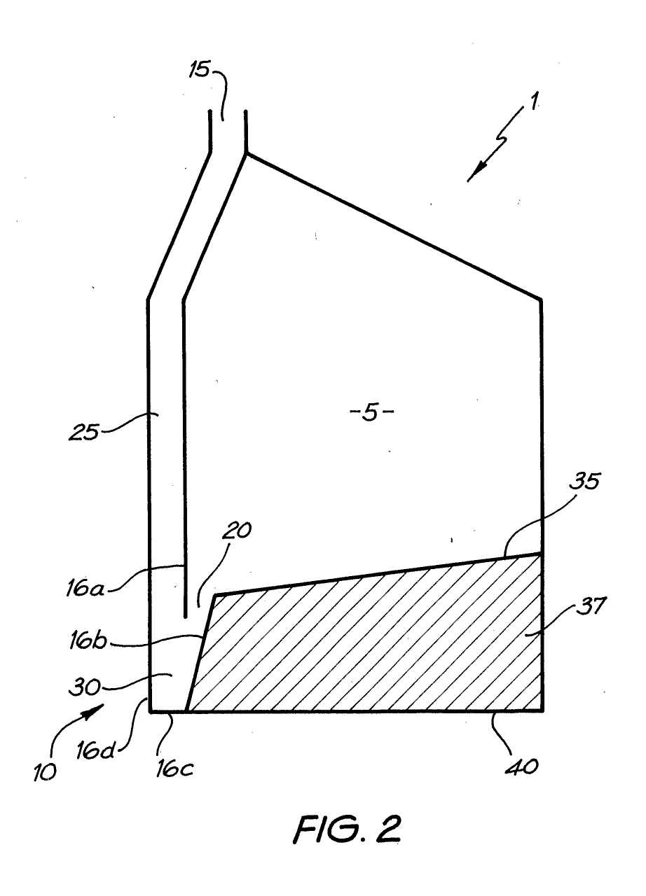

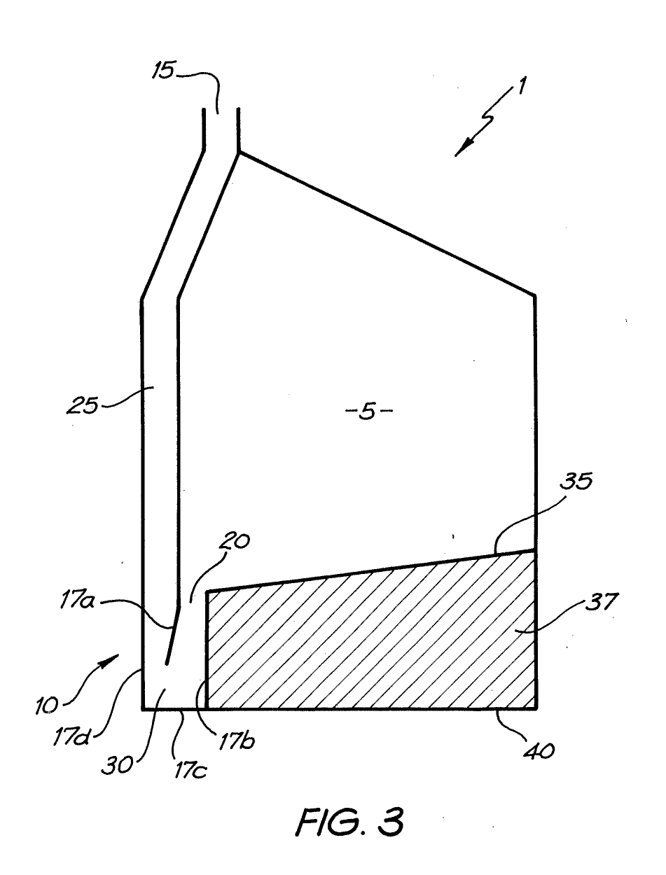

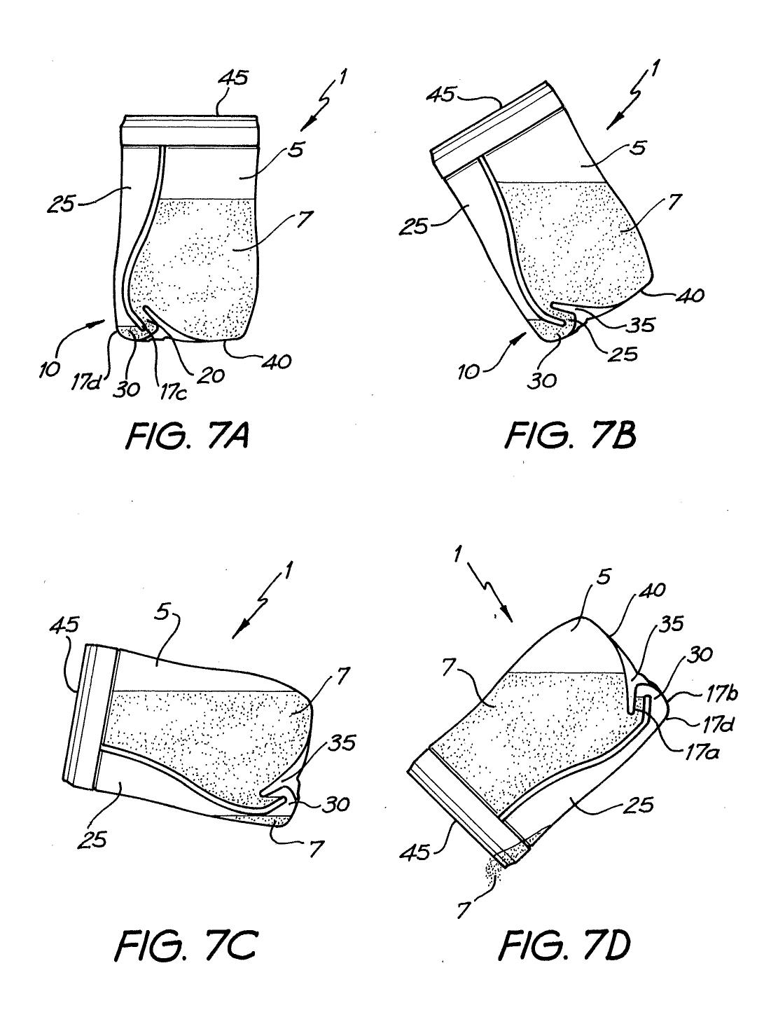

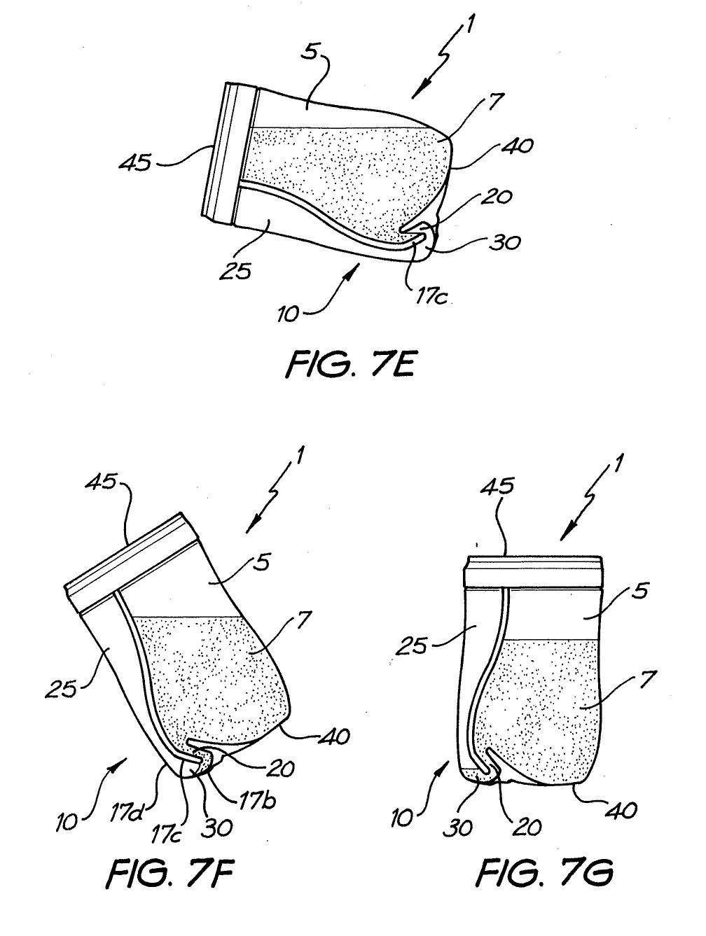

Referring to the drawings there is shown a container 1 having an interior 5 to receive particulate material 7. The particulate material 7 could be, for example, sugar, sand, salt, grains, nuts, coffee, 100 and 1000's, washing powder or other such materials. The container 1 is generally not for use with a liquid. The container 1 includes a passage 10 extending between the interior 5 to an opening 15 by which the material 7 is dispensed from the container 1. Means are located along the passage 10 and are operable to limit a measured amount of the material 7 to be dispensed from the container 1 at one time. The means shown in FIG. 1, includes walls or surfaces 15a,b,c,d,e angularly offset from each other to alter a direction of the passage 10 to thereby define the measured amount. A first passage section 20 extends from the interior 5, a second passage section 25 extends from the opening 15 towards the first passage section 20 and a third passage section 30 defines a chamber between the first and second sections 20, 25. Alternate embodiments are shown in FIGS. 2 to 5, 6a-6c and 7a-7g. In FIG. 2, the angularly offset walls or surfaces are shown as items 16a,b,c,d; in FIG. 3 as 17a,b,c,d and in FIGS. 7a to g as 18a,b,c,d.

As shown in the drawings, the three passage sections 20, 25, 30 substantially reverse the direction of the passage 10 from the interior 5 to the opening 15. It should be understood that different embodiments of the invention having the passage 10 being formed by more or less angularly offset walls or surfaces is within the scope of the invention. To assist the material 7 in the interior 5 to move into the first passage section 20, the interior 5 can include a wall or barrier 35 angularly offset to a side of the container 1 and, in particular, the container base 40. The wall 35 may be part of a block 37 as shown in FIGS. 1 to 3 or may be integrally formed, hollow or any like arrangement.

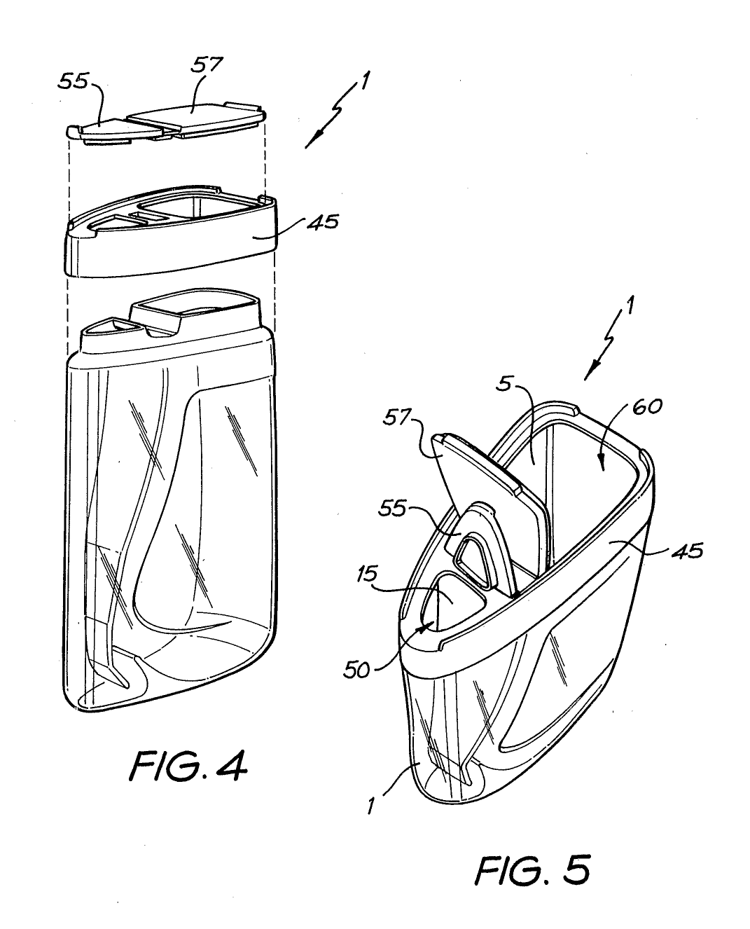

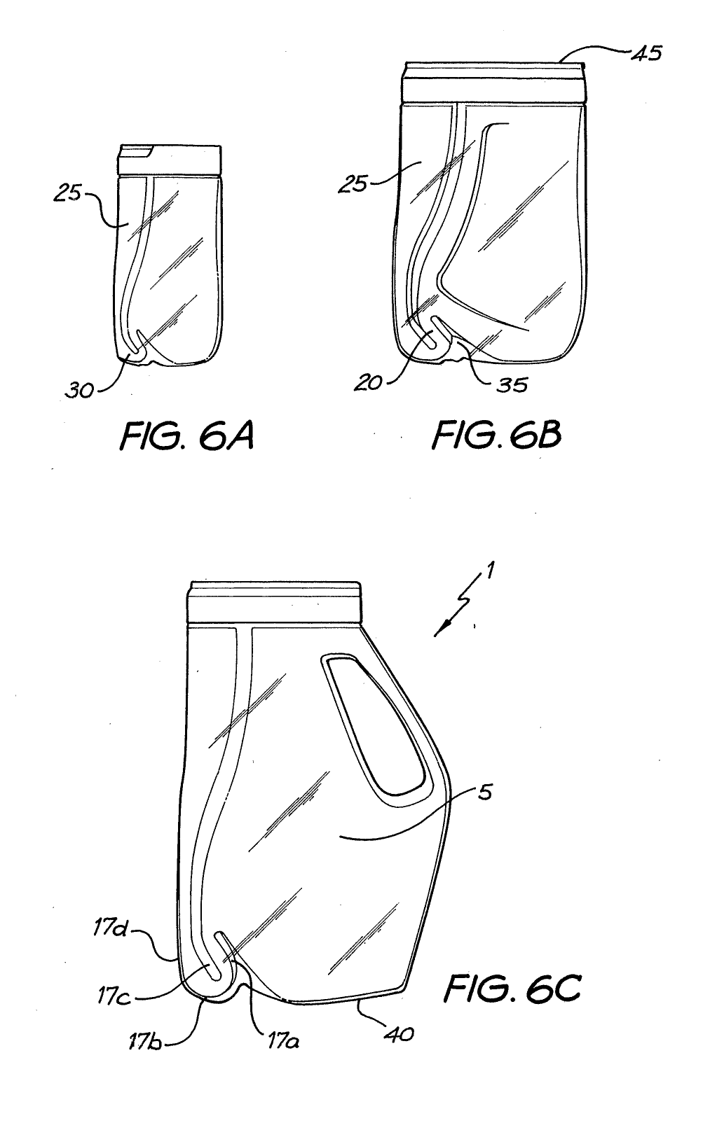

As best seen in FIGS. 4 and 5, the container 1 can include a lid or cap 45 secured to the top of the container 1 to further assist in dispensing particulate material 7 from the interior 5. The lid or cap 45 can include a first aperture 50 providing access to the opening 15 of the second passage 25. The aperture 50 can include a flip-top portion 55 or the like as shown in FIG. 5. The lid or cap 45 could also include a second aperture 60 providing access to the interior 5 for filling the container 1. The second aperture 60 could also include a flip-top portion 57 or the like as also shown in FIG. 5. The lid or cap 45 in the preferred form would be an injection moulded polypropylene 1 or 2-part piece. The container 1 would preferably be a blow moulded HTPE. However, the lid or cap 45 and container 1 could be manufactured using most typical manufacturing processes and materials. The passage 10 can be of various shapes and sizes for example a spiral.

In use, and as best seen in FIGS. 7a to 7g the interior 5 would be filled with a particulate material 7 by way of second aperture 60. The particulate material 7 substantially moves under gravity towards the first passage section 20. The bulk of the particulate material 7 is held in the interior 5. A predetermined amount of particulate material 7 will settle in the chamber 30 as shown in FIG. 7a. Due to the friction between the particles 7 and the angular walls or surfaces 17a,b,c,d the first passage 20 will become blocked preventing further material 7 from settling in the chamber 30. At this stage, the container 1 has been primed and is ready for use. As shown in FIGS. 7b,c, and d a user rotates the container 1 with the particulate material 7 of the chamber 30 moving into the second passage 25 towards and out the opening 15. As the container 1 is further rotated as seen in FIG. 7c due to the angular offsets further particulate material 7 from the interior 5 cannot flow into the chamber 30 and only the predetermined amount can proceed down passage 25 and out the opening 15. Referring to FIGS. 7e to g once the predetermined amount of particulate material 7 has been dispensed from the container 1, the user re-orientates the container 1 and the particulate material 7 from the interior 5 reloads the chamber 30 by gravity drawing the contents to the lowest point. The chamber 30 once filled is ready for the next dispensing action.

Accordingly, the present invention provides a container 1 having no moving parts which dispenses a measured amount of granular or particulate material 7 until the container 1 is completely exhausted of material 7 at which time it can be refilled. The container 1 is simple, efficient and affordable to manufacture and does not require a minimum amount of material 7 to function. Advantageously, only the material 7 in the chamber 30 is allowed to exit with the remainder of the material 7 moving back into the interior 5. It is also conveniently designed to substantially prevent children from spilling the material 7.

Although the invention has been described with reference to specific examples, it will be appreciated by those skilled in the art that the invention may be embodied in many other forms.

1. A container having an interior to receive particulate material, said container having:
a passage extending between said interior to an opening by which said material is dispensed from said container when rotated clockwise or anti-clockwise;
means located along said passage adjacent a base of said container and operable to limit a measured amount of said material to be dispensed from said container at one time;
said means including surfaces offset from each other to alter a direction of said passage to thereby define said measured amount, said surfaces forming a first passage section extending from said interior, a second passage section extending to said opening and a third passage section defining a chamber between said first and second sections;
whereby said sections substantially reverse the direction of said passage from said interior to said opening and located at an entrance to and exit from said first passage are respective overlapping lips.

2. The container according to claim 1, wherein said material in use moves from said interior to said chamber to settle until dispensed said measured amount being defined by the amount of said material located in said chamber before said material within said first section blocks and said first section, said first section unblocking once said material within said chamber is dispensed from said container.

3. The container according to claim 1 or 2, whereby when said container is inverted, said material in said first section is inhibited from exiting said container.

4. The container according to any one of claims 1 to 3, wherein said offset surfaces are angularly offset from a perpendicular to the base.

5. The container according to any one of the preceding claims, wherein said interior includes a wall angularly offset to a side of said container.

6. The container according to claim 5, wherein said side of said container is said base.

7. The container according to any one of the preceding claims, wherein said container is integrally formed.

8. The container according to claim 1, wherein said passage forms a spiral.

9. The container according to any one of the preceding claims, wherein said container includes a cap or lid.

10. The container according to claim 9, wherein said cap or lid includes and aperture to access said opening.

11. The container according to claim 9, wherein said cap or lid includes an aperture to access said interior.
